(19) United States
(12) Patent Application Publication
(10) Pub. No.: US 2025/0225257 A1
(43) Pub. Date: Jul. 10, 2025

(54) METHOD AND SYSTEM FOR ENHANCING SECURITY ASSOCIATED WITH AN ARTIFICIAL INTELLIGENCE OPERATION AND IMPROVING PERFORMANCE

(71) Applicant: Marvell Asia Pte Ltd, Singapore (SG)

(72) Inventors: Deepanshu Tyagi, Hapur (IN); Dhanalakshmi Saravanan, Koramangala (IN); Prateek Johri, Bareilly (IN)

(21) Appl. No.: 18/745,384

(22) Filed: Jun. 17, 2024

Related U.S. Application Data
(60) Provisional application No. 63/617,509, filed on Jan. 4, 2024.

(51) Int. Cl. G06F 21/60; G06N 20/00

(52) U.S. Cl. CPC G06F 21/602; G06N 20/00

(57) ABSTRACT

A system includes a hardware security module (HSM) configured to receive an artificial intelligence (AI) request sent by an application. The AI request is a request to perform one or more AI related operations. The HSM is configured to perform one or more cryptographical operations associated with the one or more AI related operations. The HSM is configured to send a result of the one or more cryptographical operations associated with the one or more AI related operations to an AI processor. The system also includes the AI processor configured to receive the result of the one or more cryptographical operations associated with the one or more AI related operations from the HSM. The AI processor is configured to perform the one or more AI related operations.

### RELATED APPLICATIONS

The instant application is a nonprovisional patent application that claims the benefit and priority to the provisional patent application No. 63/617,509 that was filed on Jan. 4, 2024, which is incorporated herein by reference in its entirety.

### BACKGROUND

Artificial Intelligence (AI) and machine learning (ML) have become prevalent in recent years with a wide variety of applications including self-driving vehicles, chat GPT, etc. Hardware architectures, e.g., accelerators, have been specifically designed to perform ML/AI related operations efficiently, given the highly intensive nature of data and complex operation (e.g., mathematical operations) in AI/ML related applications. In certain traditional systems, a processor that is not specifically designed to perform one or more AI operations may be used.

AI/ML related operations may involve sensitive data. Accordingly, one or more cryptographical operations may be performed on the data to protect the sensitive data before the data is sent by the application to an accelerator for processing. The accelerator that may have been designed specifically to perform AI/ML related operations efficiently may be now tasked with performing cryptographical operations, which is not designed to do efficiently, first before it can perform one or more AI/ML related operations on the data, resulting in performance degradation.

In traditional cases where a processor that is not specifically designed to perform the AI/ML related operation is used to perform AI/ML related operations may similarly be tasked to perform one or more cryptographical operations. Since a traditional processor is not specifically designed to perform cryptographical operations efficiently, having the processor perform the cryptographical operations before it can perform the AI/ML operations results in performance degradation.

Furthermore, using the same accelerator or the same processor to perform not only the AI/ML operations but also to perform one or more cryptographical operations results in the system being more vulnerable to security attacks. For example, since the same accelerator or the same processor is used to perform both cryptographical operations as well as the AI/ML operations, the system operates in the same environment (e.g., no isolation between key management and processing environment), thereby increasing vulnerability of system security.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 depicts an example of a diagram of a system to enhance security associated with an AI/ML operation and improving performance according to one aspect of the present embodiments.

FIG. 2 depicts an example of a diagram of a hardware security module (HSM) according to one aspect of the present embodiments.

FIGS. 3A-3D depict an example of an AI/ML request being processed by a system according to one aspect of the present embodiments.

FIG. 4 depicts a flowchart of an example of a process to perform an AI/ML operation request according to one aspect of the present embodiments.

### DETAILED DESCRIPTION

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Before various embodiments are described in greater detail, it should be understood that the embodiments are not limiting, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein. It should also be understood that the terminology used herein is for the purpose of describing the certain concepts, and the terminology is not intended to be limiting. Unless defined otherwise, all technical and scientific terms used herein have the same meaning as commonly understood in the art to which the embodiments pertain.

A need has arisen to perform cryptographic operations associated with AI/ML related requests to enhance the security of data in a way to also improve performance, e.g., speed, etc. In one nonlimiting example, a request or data associated with an AI/ML operation is sent by an application and received by the system. The system may utilize a hardware security module (HSM) to perform one or more cryptographical operations associated with the request or data in an efficient manner. An HSM is a physical computing device that safeguards and manages secret and confidential information (e.g., digital keys and data) of a user which applications use the HSM. HSMs typically have certain security protection measures in place to prevent tampering by cyberattacks and play a vital role in providing a security environment for various cryptographic operations such as encryption and decryption, digital signatures, strong authentication, as well as other cryptographic functions. HSMs are mainly used to generate, derive, store, and manage cryptographic keys, secure computation via encryption and decryption, and protect sensitive data of the user from unauthorized access and attacks.

The result of the cryptographical operation may be sent to an AI processor, e.g., accelerator, CPU, GPU, etc., for performing the AI/ML operation. In other words, the cryptographical operation that enhances security of the data or request associated with the AI/ML operation is offloaded to the HSM that is designed to perform cryptographical operations efficiently, thereby enhancing security while improving performance. The result of the cryptographical operation, e.g., plain data, etc., may be sent to the AI processor to perform the AI/ML operation. In one nonlimiting example, the AI processor may be an accelerator that is designed to perform AI/ML operations efficiently. As such, the AI processor is used to perform AI/ML operations efficiently and will not be burdened with performing cryptographical operations that is not designed to do efficiently, thereby improving performance. Additionally, using an HSM and an AI processor that are physically separate from one another, improves the security and reduces the security vulnerability of the system by separating the cryptographical environment from the processing environment (e.g., AI/ML operations).

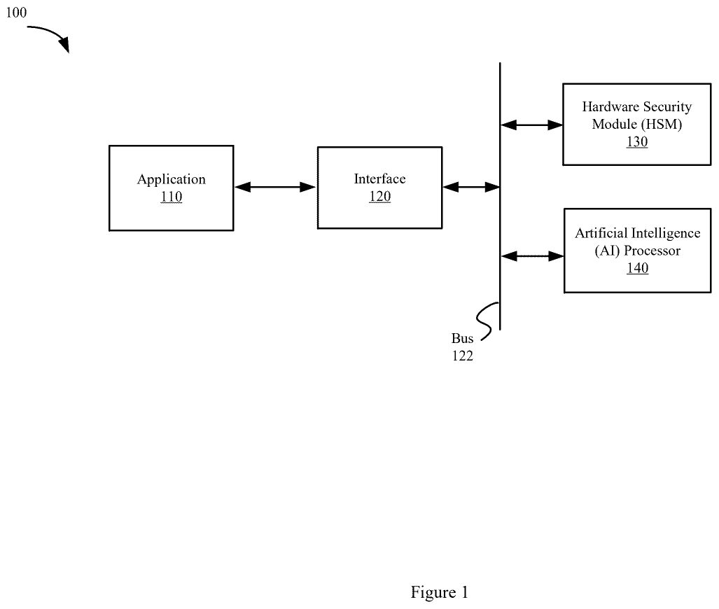

FIG. 1 depicts an example of a diagram of a system to enhance security associated with an AI/ML operation and improving performance according to one aspect of the present embodiments. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

In the example of FIG. 1, the system 100 includes an application 110 running on a host that generates one or more requests for performing an AI/ML operation and may send data associated with the request. In one nonlimiting example, the application 110 may be an application running on a hardware for self-driving vehicle, for image recognition, for natural processing language, etc. In one nonlimiting example, the application 110 can be but is not limited to a cloud-based user application, e.g., one hosted by a web service such as Amazon Web Service (AWS). An interface 120 may receive the request and/or data associated with the request to perform one or more ML operations from the application 110. In one nonlimiting example, the application 110 may communicate with the interface 120 over a network (not shown) following certain communication protocols such as TCP/IP protocol. Such a network can be but is not limited to, internet, intranet, wide area network (WAN), local area network (LAN), wireless network, Bluetooth, WiFi, mobile communication network, or any other network type. In one nonlimiting example, the request and/or data received from the application 110 may include sensitive data/information (e.g., bias values for an AI/ML model) and may as such be protected by the application 110, e.g., encrypted.

In some embodiments, the interface 120 may send the request/data associated with the AI/ML operations as received from the application 110 to an HSM 130, via a bus 122, to perform one or more cryptographical operations. In one nonlimiting example the HSM 130 may include a multi-chip embedded hardware/firmware cryptographic module having software, firmware, hardware, or another component that is used to effectuate a purpose. In some embodiments, the one or more processors include a multi-core processor and a security processor, wherein the security processor is configured to perform crypto operations with hardware accelerators with embedded software implementing security algorithms. In some embodiments, the HSM 130 is certified under Federal Information Processing Standard (FIPS) Level 2 and 3 for performing secured key management cryptographic (crypto) operations. In some embodiments, the HSM 130 is preconfigured with default network and authentication credentials so that the HSM 130 can be FIPS/Common Criteria/PCI compliant for key management and crypto operations. In some embodiments, the FIPS certified HSM 130 includes one or more processors and storage units (not shown). In one nonlimiting example, the cryptographical operations may include one or more of key management, encryption/decryption, digital signature and verification, authentication, auditing, secure code execution, etc. HSM 130 is designed to perform cryptographical operations efficiently, thereby improving performance in comparison to other hardware components that are not specifically designed to perform the cryptographical operations, e.g., CPU, GPU, inference engine, etc. The result of the cryptographical operation, e.g., plain data, may be sent by the HSM 130 to the AI processor 140 for execution, via the bus 122.

In some embodiments, the AI processor 140 may be designed specifically to perform AI/ML operations in a highly efficient manner. The AI processor 140 may be an ML hardware specifically designed to perform AI/ML operations in an efficient manner or it may be a CPU or a GPU, as examples. In one nonlimiting example, the AI/ML operation may be associated with an ML model and may be computationally intensive. However, since the AI processor 140 may be specifically designed to perform AI/ML operations efficiently, the performance of the system may be improved.

It is appreciated that since the interface 120 sends cryptographical operations to be performed by HSM 130, the performance and security of the system is improved. Moreover, since the cryptographical operations are performed by the HSM 130, the resources of the AI processor 140 are not burdened with operations that they are not designed for. In other words, the cryptographical operations are offloaded to be performed by the HSM 130 that is designed to perform cryptographical operations as opposed to a processor designed for performing AI/ML operation or a general processor, thereby improving efficiency, speed, and resource utilization in the system. It is further appreciated that the security is improved by physically separating the cryptographical environment from the processing environment. In one nonlimiting example, once the AI processor 140 performs its AI/ML operations, the results may be sent to the HSM 130 for cryptographical operations to be performed before the results is output and sent back to the application 110 via the interface 120.

It is appreciated that one HSM is shown for illustration purposes, and it should not be construed as limiting the embodiments. For example, multiple HSMs may be used.

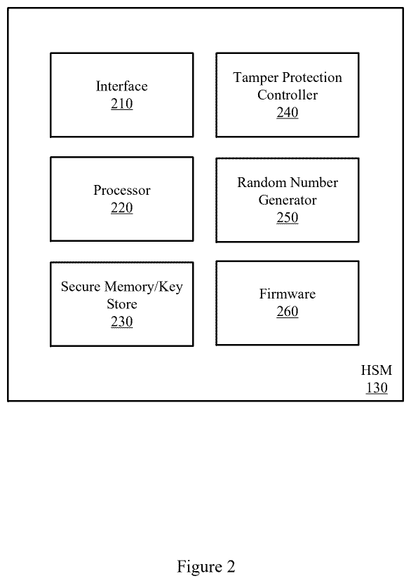

FIG. 2 depicts an example of a diagram of an HSM 130 according to one aspect of the present embodiments. In one nonlimiting example, the HSM 130 may include multiple modules including one or more of interface 210 (in this nonlimiting example interface 210 is different from the interface 120), processor 220, secure memory/key store 230, tamper protection controller 240, random number generator 250, and a firmware 260.

According to one example, the interface 210 may receive the requests, e.g., request and/or data associated with one or more cryptographic operations. In this example, the cryptographical operation may be associated with an AI/ML operation request and may include data associated with the AI/ML operation. The interface 210 may be configured to parse each of the plurality of service requests and to identify a type of service requested by a specific application. Various types of service requests may be any cryptographic operations including but are not limited to key management (e.g., key generation, key export, key deletion, secured key and data storage), crypto (e.g., encryption and decryption) operations of the keys and data, digital signature and verification (e.g., generate digital signature and verification), authentication (to ensure that only authorized users and systems can access certain data (e.g., sensitive data and/or service such as bias/weights associated with an AI/ML model)), auditing (for forensic analysis and compliance), secure code execution (to execute custom code in secure boundaries), etc. The interface 210 then invokes the corresponding handler/component of the key management and crypto operation module to process the specific type of service requested by the application together with the data embedded in or pointed to by the service request. Once the service request has been processed by the key management and crypto operation module, the interface 210 may compose a response including a processing result and transmit the response back to the application sending the service request.

In one nonlimiting example, the processor 220 may be used to perform one or more types of service request. For example, the processor 220 may be configured to perform a key management (by using the secure memory/key store 230) or crypto operation/service (e.g., advanced encryption standard (AES) operation, data encryption standard (DES) operation, etc.) according to the type of service requested. For non-limiting examples, the key management or crypto operation can be but is not limited to, generating a new key, storing the key into the key store 230, exporting the key back to the application 110 or AI processor 140, deleting an existing key from the key store 230, encrypting or decrypting data using the key, and storing the encrypted or decrypted data in the key store 230. The key store 230 may be a secure memory component used for key management. The processor 220 may use the secure memory/key store 230 for key management and crypto operation and further to provide the processing result (e.g., the generated key) back to the requesting application 110 or to the AI processor 140 through the interface 210, bus 122 and/or interface 120. In some embodiments, the key management and crypto operation may be configured to stop or abort the key management or crypto operation if an alert of potential security compromise is raised for the specific operation and/or the application requesting the service.

In one nonlimiting example, the secure memory/key store 230 is configured to maintain various types of information/data associated with the plurality of applications in a secure environment. Such information includes but is not limited to keys, encrypted data, decrypted data and any other confidential or proprietary information of each of the plurality of applications. In some embodiments, the secure memory/key store 230 includes multiple types of storage devices, including but not limited to, dynamic random access memory (DRAM) and flash for key and data storage, ferroelectric RAM (FRAM) for storing critical logs, and eFuse for one time key write that cannot be erased, etc.

According to one nonlimiting example, the tamper protection controller 240 may be used to ensure that the data and/or request is not tampered with and if the tamper protection controller 240 detects tampering, then the request and/or operation may be aborted. In one nonlimiting example, the random number generator 250 may be used to generate a random number that may be used for encryption/decryption. The HSM 130 may include the firmware 260, in one nonlimiting example. According to one nonlimiting example, the result (e.g., plain data) associated with the AI/ML operation and/or data may be output from the HSM 130 to the AI processor 140 for the AI processor 140 to perform one or more AI/ML operations. In one example, the AI/ML operation may include complex mathematical operation associated with an ML model.

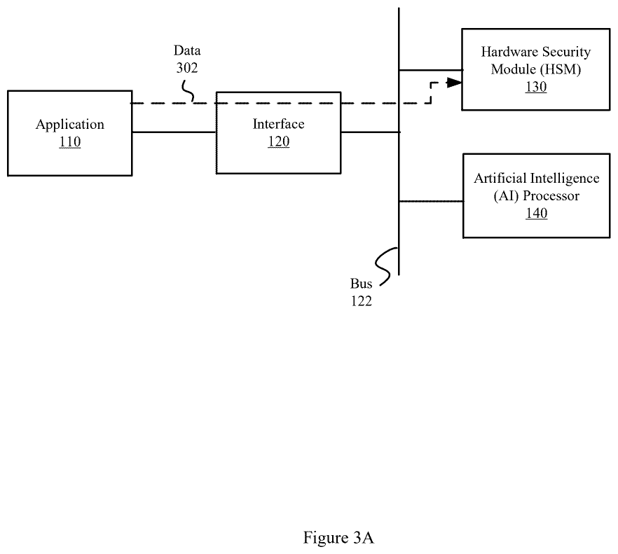

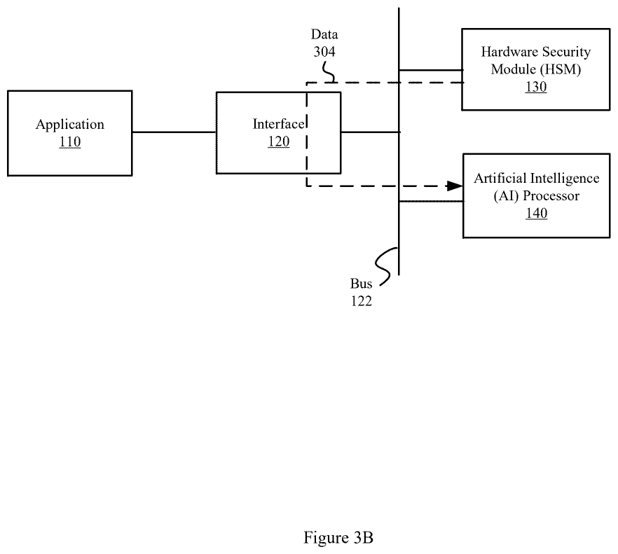

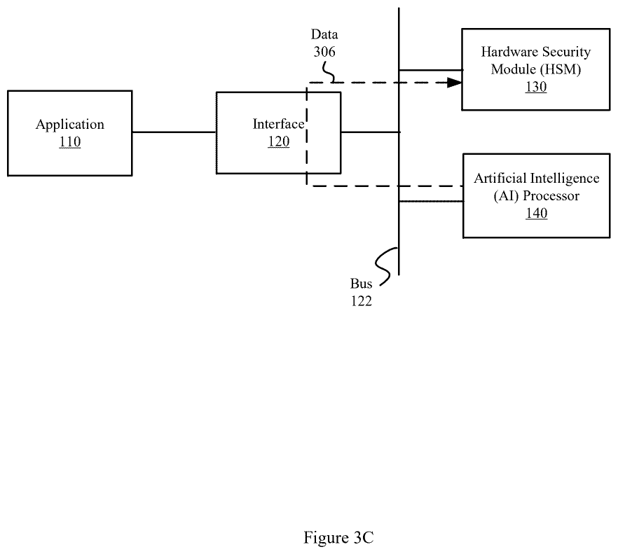

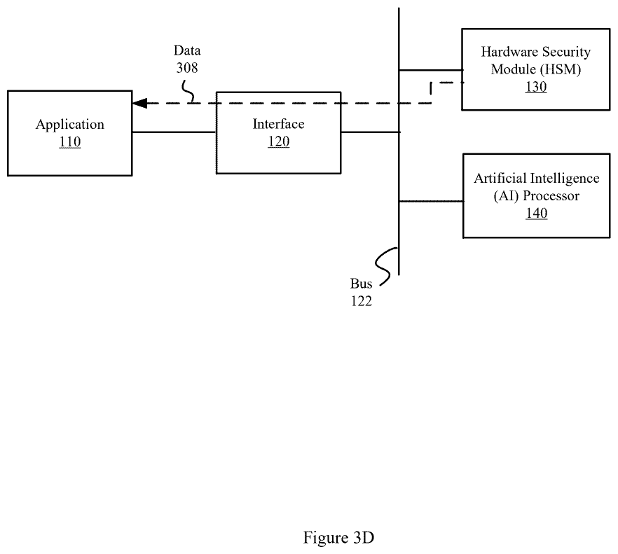

FIGS. 3A-3D depict an example of an AI/ML request being processed by a system according to one aspect of the present embodiments. Referring now to FIG. 3A, data 302, e.g., request and/or data associated with an ML/AI operation, is sent from the application 110 via the interface 120 to the HSM 130 for performing one or more cryptographical operations, as described in FIGS. 1 and 2 above. The data 302 may be received as encrypted data to improve the security. For example, the data 302 may include the bias or weights associated with a particular ML model or operation. It is appreciated that HSM 130 is designed to perform one or more cryptographical operations efficiently. The HSM 130 may utilize the processor 220 (which may be an accelerator) for performing the cryptographical operations efficiently, e.g., high resource utilization and reduced latency. As such, cryptographical operations associated with the AI/ML request and/or data are offloaded to HSM 130 instead of having the AI processor 140 to perform the cryptographical operations. Since the AI processor 140 is designed to achieve high performance for AI/ML operations it may be unable to achieve similar performance for cryptographical operations. As such, leveraging HSM 130 improves efficiency and resource utilization. Moreover, creating a separation between the cryptographical environment and the AI processing environment improves the security of the system in comparison to a single environment where cryptographical operation and the AI processing is performed.

Referring now to FIG. 3B, the result of the cryptographical operation may be sent to the AI processor 140 such that the AI/ML operation can be performed efficiently by the AI processor 140. In this nonlimiting example, the result may be data 304 that is sent from the HSM 130 to the AI processor 140 via the interface 120 and/or the bus 122. The data 304 may be plain data (e.g., unencrypted). The data 304 may be the result of the cryptographic operations, as described above with respect to FIGS. 1 and 2, e.g., authentication, signature verification, encryption/decryption, etc. It is appreciated that the performance of the system is improved since the AI processor 140 may be designed to perform one or more AI/ML operation efficiently. It is appreciated that the performance of the system may be improved even if the AI processor 140 is not designed specifically to perform AI/ML operations, e.g., CPU, GPU, etc., because the cryptographical operations is still performed by a component such as the HSM 130 that is designed to perform cryptographical operations efficiently. The AI processor 140 generates data 306 as its result of AI/ML processing, as shown in FIG. 3C. The data 306 may be in unencrypted form when it is sent from the AI processor 140 to the HSM 130 via the bus 122 and/or the interface 120. According to one nonlimiting example, the data 306 is sent from the AI processor 140 to the HSM 130 to perform one or more cryptographical operations, as described in FIGS. 1 and 2 above, on data 306 to generate a result, e.g., encrypted form as an example. As such, the data 308 (e.g., encrypted data) generated by the HSM 130 may now be sent back to the application 110 that requested the AI/ML operations via the bus 122 and/or interface 120, as shown in FIG. 3D.

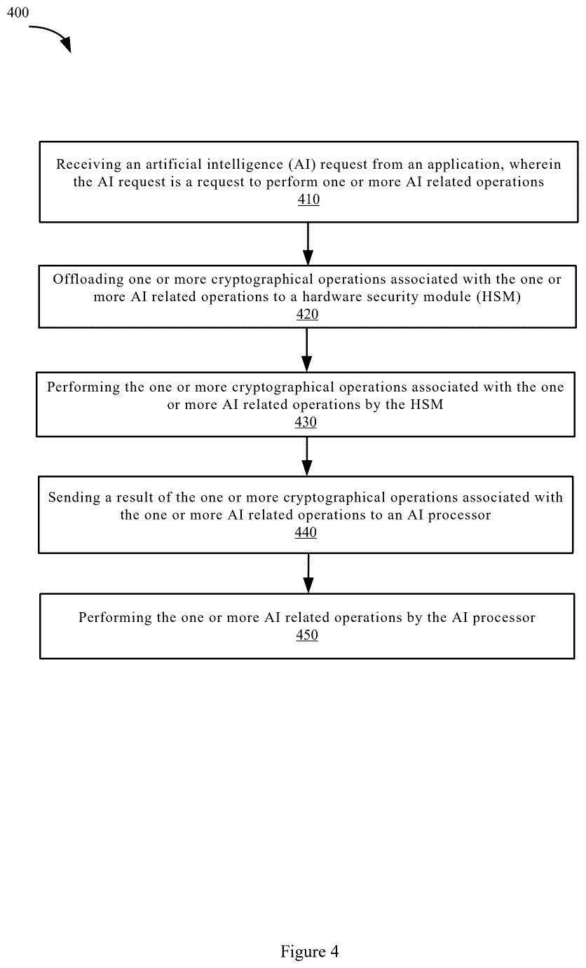

FIG. 4 depicts a flowchart of an example of a process to perform an AI/ML operation request according to one aspect of the present embodiments. At step 410, an AI request (e.g., data or operation request) may be received from an application. The AI request may be a request to perform one or more AI related operations, e.g., Sigmoid operation, Softmax operation, etc. At step 420, one or more cryptographical operations associated with the one or more AI related operation is offloaded to an HSM, as described above in FIGS. 1-3D. At step 430, the one or more cryptographical operations associated with the one or more AI related operations is performed by the HSM, as described above in FIGS. 1-3D. At step 440, a result of the one or more cryptographical operations associated with the one or more AI related operations is sent to an AI processor, e.g., as described above in FIGS. 1-3D. At step 450, the one or more AI related operations are performed by the AI processor, as described above. In one nonlimiting example, the result of the AI operations by the AI processor may be sent to the HSM for performing one or more cryptographical operations on the result of the AI operations before it is sent back to the application that requested the AI operation.

As such, the cryptographical operations are offloaded from the AI processor to be performed by the HSM that is better suited to handle cryptographical operations. As such, performance is improved as well as security, e.g., by separating the cryptographical operating environment from the AI processing environment. The AI processor is therefore relieved from performing cryptographical operations and can perform the AI operations (processing) on the data received from the HSM. As such, not only security and performance are improved but efficiency and resource utilization are also increased.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Embodiments were chosen and described in order to best describe the principles of the invention and its practical application, thereby enabling others skilled in the relevant art to understand the claimed subject matter, the various embodiments and the various modifications that are suited to the particular use contemplated.

What is claimed is:

1. A system comprising:
a hardware security module (HSM);
an interface configured to receive an artificial intelligence (AI) request from an application, wherein the AI request is a request to perform one or more AI related operations; and
an AI processor,
wherein the interface is configured to offload one or more cryptographical operations associated with the one or more AI related operations to the HSM,
and wherein the HSM is configured to perform the one or more cryptographical operations associated with the one or more AI related operations, and wherein the HSM is configured to send a result of the one or more cryptographical operations associated with the one or more AI related operations to the AI processor,
and wherein the AI processor is configured to receive the result of the one or more cryptographical operations associated with the one or more AI related operations from the HSM, and wherein the AI processor is configured to perform the one or more AI related operations.

2. The system of claim 1, wherein the HSM is a hardware component that is separate from the AI processor.

3. The system of claim 1, wherein the AI processor is a central processing unit (CPU) or a graphics pipeline unit (GPU).

4. The system of claim 1, wherein the one or more cryptographical operations is at least one or more of encryption/decryption, digital signature and verification, authentication, auditing, secure code execution, key management, and tamper protection.

5. The system of claim 1, wherein the interface receives data associated with the AI request in encrypted format.

6. The system of claim 5, wherein the interface is configured to send the data in the encrypted format to the HSM, and wherein the HSM is configured to decrypt the data to form a plain data, and wherein the HSM is configured to send the plain data to the AI processor, wherein the plain data is used by the AI processor to process the one or more AI related operations.

7. The system of claim 6, wherein the AI processor is configured to send a result of the processing the one or more AI related operations in an unencrypted format to the HSM, and wherein the HSM is configured to encrypt the result of the processing the one or more AI related operations and subsequently send the encrypted result of the processing the one or more AI related operations to the interface.

8. The system of claim 7, wherein the interface is configured to send the encrypted result of the processing the one or more AI related operations to the application.

9. The system of claim 1, wherein the one or more AI related operations is related to an AI model.

10. A method comprising:
receiving an artificial intelligence (AI) request from an application, wherein the AI request is a request to perform one or more AI related operations;
offloading one or more cryptographical operations associated with the one or more AI related operations to a hardware security module (HSM);
performing the one or more cryptographical operations associated with the one or more AI related operations by the HSM;
sending a result of the one or more cryptographical operations associated with the one or more AI related operations to an AI processor; and
performing the one or more AI related operations by the AI processor.

11. The method of claim 10, wherein the HSM is separate from the AI processor.

12. The method of claim 10, wherein the one or more cryptographical operations is at least one or more of encryption/decryption, digital signature and verification, authentication, auditing, secure code execution, key management, and tamper protection.

13. The method of claim 10 further comprising receiving data associated with the AI request in encrypted format from the application.

14. The method of claim 13, wherein the data is received by the HSM, and wherein the method further comprises:
decrypting the data to form a plain data;
sending the plain data to the AI processor; and
performing the one or more AI related operations, by the AI processor, based on the plain data.

15. The method of claim 14 further comprising:
sending a result of the processing the one or more AI related operations in an unencrypted format from the AI processor to the HSM;
encrypting the result of the processing the one or more AI related operations in the unencrypted format using the HSM; and
sending the encrypted result of the processing the one or more AI related operations to the application.

16. The method of claim 10, wherein the one or more AI related operations is related to an AI model.

17. A system comprising:
a hardware security module (HSM) configured to receive an artificial intelligence (AI) request sent by an application, wherein the AI request is a request to perform one or more AI related operations, wherein the HSM is configured to perform one or more cryptographical operations associated with the one or more AI related operations, and wherein the HSM is configured to send a result of the one or more cryptographical operations associated with the one or more AI related operations to an AI processor; and
the AI processor configured to receive the result of the one or more cryptographical operations associated with the one or more AI related operations from the HSM, and wherein the AI processor is configured to perform the one or more AI related operations.

18. The system of claim 17, wherein the HSM is a hardware component that is separate from the AI processor.

19. The system of claim 17, wherein the AI processor is a central processing unit (CPU) or a graphics pipeline unit (GPU).

20. The system of claim 17, wherein the one or more cryptographical operations is at least one or more of encryption/decryption, digital signature and verification, authentication, auditing, secure code execution, key management, and tamper protection.

21. The system of claim 17, wherein the HSM receives data associated with the AI request in encrypted format.

22. The system of claim 21, wherein the HSM is configured to decrypt the data to form a plain data, and wherein the HSM is configured to send the plain data to the AI processor, wherein the plain data is used by the AI processor to process the one or more AI related operations.

23. The system of claim 22, wherein the AI processor is configured to send a result of the processing the one or more AI related operations in an unencrypted format to the HSM, and wherein the HSM is configured to encrypt the result of the processing the one or more AI related operations and subsequently send the encrypted result of the processing the one or more AI related operations to the application.

24. The system of claim 17, wherein the one or more AI related operations is related to an AI model.

25. A system comprising:
a means for receiving an artificial intelligence (AI) request from an application, wherein the AI request is a request to perform one or more AI related operations;
a means for offloading one or more cryptographical operations associated with the one or more AI related operations to a hardware security module (HSM);
a means for performing the one or more cryptographical operations associated with the one or more AI related operations by the HSM;
a means for sending a result of the one or more cryptographical operations associated with the one or more AI related operations to an AI processor; and
a means for performing the one or more AI related operations by the AI processor.
